(19) United States
(12) Patent Application Publication
(10) Pub. No.: US 2025/0207451 A1
(43) Pub. Date: Jun. 26, 2025

(54) NOVEL CAM ACTION HYDRAULIC DOOR CLOSER

(71) Applicant: SUN-Q DOOR CONTROLS LIMITED, YUANLIN CITY (TW)

(72) Inventors: Tsung-Ching CHEN, YUANLIN CITY (TW); Yuan-Man CHEN, DONGGUAN CITY (CN)

(21) Appl. No.: 18/987,669

(22) Filed: Dec. 19, 2024

(30) Foreign Application Priority Data
Dec. 20, 2023 (CN) 202323487816.5

(51) Int. Cl. E05F 15/50

(52) U.S. Cl. CPC E05F 15/50; E05Y 2201/256; E05Y 2201/474; E05Y 2201/638

(57) ABSTRACT

The present invention relates to a novel cam action hydraulic door closer wherein gear and rack structure is excluded, that greatly simplifies the structure and volume of the door closer. The bidirectional piston is consistently flexibly abutted against the outer peripheral surface of the transmission camshaft by the drive spring. The transmission camshaft, when working, drives the bidirectional piston to tightly press the drive spring, making it store force. Meanwhile, the overload valve realizes hydraulic oil flowing between the main shaft chamber and the spring chamber. Therefore, during the door closer housing rotates, the transmission camshaft receives the damping effect from the bidirectional piston and the hydraulic oil, lowering the transient door closing speed, so that the cam action hydraulic door closer achieves sufficient buffering when the door closes. The present invention has simple structure, convenience in assembly, high production efficiency, low failure rate and stable performance.

### BACKGROUND OF THE INVENTION

### 1. Field of the Invention

The present invention belongs to the technical field of door closers, and particularly relates to a novel cam action hydraulic door closer.

### 2. Description of the Related Art

Door closers are primarily used in commercial and public buildings, but also used in homes. They have many purposes, wherein the primary purpose is to make doors close by themselves for limiting the spread of fire and ventilation in buildings.

The basic components of a hydraulic door closer include a supporting guider, a transmission gear, a position restoring spring, a one-way valve, a rack plunger, a throttle valve core, a housing, an end cap, a sealing ring and a linkage. The housing and the linkage have the functions of fixing the door closer and connecting the door body with the door frame. When the door is opened, the door body moves the linkage and rotates the transmission gear to drive the rack plunger to move to the right. During the plunger moving to the right, the spring is compressed, and the hydraulic oil in the right chamber is also compressed. Under the hydraulic pressure, the sphere of the one-way valve located at the left side of the plunger is opened. The hydraulic oil in the right chamber flows to the left chamber through the one-way valve. When the door opening process is finished, the stored elastic potential energy due to the spring being compressed during the opening process is released to push the plunger to the left, that rotates the transmission gear and the door closer linkage to close the door.

However, the currently commercially available door closers have a large number of components, having the disadvantages of complicated structure, low production efficiency, high failure rate and unstable performance.

### SUMMARY OF THE INVENTION

It is an objective of the present invention to provide a novel cam action hydraulic door closer, which can solve the technical problem in the existing technology that the door closer has a large number of components, having complicated structure, low production efficiency, high failure rate and unstable performance.

To attain the above objective, the embodiment of the present invention provides a novel cam action hydraulic door closer which includes:
a door closer housing, the door closer housing being provided therein along the axis direction thereof with an inner chamber filled with hydraulic oil;
a bidirectional piston, the bidirectional piston being movably inserted in the inner chamber and partitioning the inner chamber into a main shaft chamber and a spring chamber;
a transmission camshaft, the axial direction of the transmission camshaft being perpendicular to the extending direction of the door closer housing, at the same time the transmission camshaft being pivoted in the door closer housing and accommodated in the main shaft chamber; and
a drive spring, the drive spring being accommodated in the spring chamber, two ends of the drive spring being abutted against the bidirectional piston and the door closer housing respectively, the drive spring being configured to drive the bidirectional piston to be abutted and pressed on the transmission camshaft;
wherein the bidirectional piston is provided therethrough with a fluid channel communicating with the main shaft chamber and the spring chamber, and an overload valve is installed in the fluid channel; the overload valve is configured in a way that if the pressure in the main shaft chamber exceeds a threshold pressure, the overload valve allows the hydraulic oil to flow between the main shaft chamber and the spring chamber.

Optionally, the overload valve includes:
a valve body, the valve body being installed in the fluid channel, at the same time the valve body being provided therethrough with a valve flow channel communicating with the main shaft chamber and the fluid channel;
a valve core member, the valve core member being movably disposed in the fluid channel for realizing the open or shut of the valve flow channel; and
a valve core spring, the valve core spring being accommodated in the fluid channel, an end of the valve core spring being abutted in the bidirectional piston, another end of the valve core spring being abutted against the valve core member for driving the valve core member to shut off the valve flow channel.

Optionally, the door closer housing is equipped with a first bushing correspondingly to the lower end of the transmission camshaft; the door closer housing is equipped with a positionally limiting installation seat correspondingly to the upper end of the transmission camshaft, and at the same time the positionally limiting installation seat is equipped with a second bushing; the midpoints of the first bushing and the second bushing are located on a same axis; the transmission camshaft is inserted in the first bushing and the second bushing.

Optionally, an outer sealing ring is disposed between the outer end surface of the positionally limiting installation seat and the door closer housing; an inner sealing ring is disposed between the inner end surface of the positionally limiting installation seat and the transmission camshaft.

Optionally, the novel cam action hydraulic door closer further includes two fastening installation members; the two fastening installation members are respectively disposed at two ends of the door closer housing symmetrically; at the same time the fastening installation member and the door closer housing are fastened to each other by several fastening screws.

Optionally, the fastening installation member is configured in an L-shape, and includes a door body connecting plate and a housing connecting plate, which are formed integrally; the door body connecting plate is disposed horizontally and fastened to a door body by several fastening screws; the housing connecting plate is disposed vertically and fastened to the door closer housing by several fastening screws.

Optionally, the door body connecting plate and the housing connecting plate are both provided therethrough with fastening holes for disposing the fastening screws.

Optionally, the door closer housing includes:
a housing main body, the housing main body being hollow inside and having two lateral openings, the transmission camshaft being pivoted to the housing main body; and
two sealing end caps, the two sealing end caps being fixedly disposed on the two lateral openings of the housing main body respectively to form the inner chamber in an enclosed manner, an end cap sealing ring being disposed between the outer end surface of the sealing end cap and the housing main body.

The above-described one or a plurality of technical scenarios of the novel cam action hydraulic door closer provided by the embodiment of the present invention at least has one of the following technical effects. The cam action hydraulic door closer excludes the gear and rack structure, that greatly simplifies the structure and volume of the door closer. The bidirectional piston is consistently flexibly abutted against the outer peripheral surface of the transmission camshaft by the drive spring. When the transmission camshaft is working, it drives the bidirectional piston to tightly press the drive spring, thereby realizing the force storing of the drive spring. At the same time, the flowing of the hydraulic oil between the main shaft chamber and the spring chamber is realized with the overload valve. Therefore, during the rotation of the door closer housing, the transmission camshaft receives the damping effect generated from the bidirectional piston to the transmission camshaft and the damping effect of the hydraulic oil, that lowers the transient door closing speed. Thus, it is realized that the cam action hydraulic door closer achieves sufficient buffering when the door closes. It can be seen that the cam action hydraulic door closer of the present invention is simple in structure, convenient in assembly, and has the advantages of high production efficiency, low failure rate and stable performance.

### BRIEF DESCRIPTION OF THE DRAWINGS

In order to more clearly illustrate the technical scenarios in the embodiment of the present invention, the accompanying figures that need to be used in the description of the embodiment or the prior art will be briefly introduced below. Obviously, the accompanying figures in the following description are only some embodiments of the present invention. For those skilled in this field, other figures can be obtained based on these figures without exerting creative effort.

FIG. 1 is a schematic view of the internal structure of the novel cam action hydraulic door closer provided by the embodiment of the present invention.

FIG. 2 is an exploded schematic view of the novel cam action hydraulic door closer provided by the embodiment of the present invention.

FIG. 3 is a schematic view showing the connection of the bidirectional piston and the overload valve provided by the embodiment of the present invention.

FIG. 4 is a schematic view of the internal structure of the door closer housing provided by the embodiment of the present invention.

### DETAILED DESCRIPTION OF THE INVENTION

Embodiments of the present invention are described in detail below. The embodiments are illustrated in the accompanying figures, wherein same or similar reference numerals throughout represent same or similar elements or elements with same or similar functions. The following embodiments described with reference to the accompanying figures are illustrative, intended to explain the embodiments of the present invention, and cannot be understood as limitations of the present invention.

In the description of the embodiments of the present invention, it should be understood that the orientation or positional relationship indicated by the terms ‘length’, ‘width’, ‘upper’, ‘lower’, ‘front’, ‘rear’, ‘left’, ‘right’, ‘vertical’, ‘horizontal’, ‘top’, ‘bottom’, ‘inner’, ‘outer’, and so on are on the basis of the orientation or positional relationship shown in the accompanying figures, just for the convenience of describing the embodiments of the present invention and simplifying the description, not indicating or implying the mentioned device or element should have the specific orientation or be composed and operated with the specific orientation, and thereby cannot be understood as limitations of the present invention.

Besides, the terms ‘first’ and ‘second’ are used for the descriptive purpose only, and cannot be understood as indicating or implying the relative importance or implying specific amount of the mentioned technical feature. Thus, features prescribed with ‘first’ and ‘second’ may explicitly or implicitly include one or more the features. In the description of the embodiments of the present invention, ‘a plurality of’ means two or more than two, unless there is additional explicit and specific limitation.

In the embodiments of the present invention, unless there is additional explicit provision and limitation, the terms ‘install’, ‘link’, ‘connect’, ‘fix’, and so on should be understood broadly. For example, they may refer to fixed connection, or may refer to detachable connection, or being an integral; they may refer to mechanical connection, or may refer to electrical connection; they may refer to direct connection, or indirect connection through intermedium, or may refer to inner communication between two elements or interaction between two elements. For those skilled in this field, the specific meanings of the aforementioned terms in the embodiments of the present invention can be understood according to specific conditions.

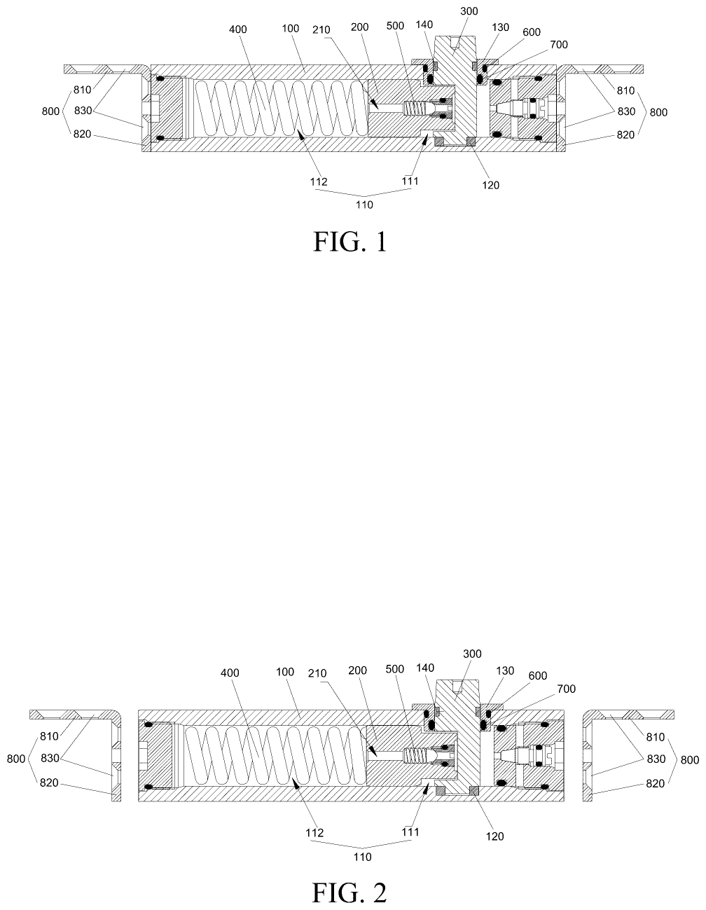

In a first embodiment of the present invention, as shown in FIG. 1, a novel cam action hydraulic door closer is provided, which includes:
a door closer housing 100, the door closer housing 100 being provided therein along the axis direction thereof with an inner chamber 110 filled with hydraulic oil;
a bidirectional piston 200, the bidirectional piston 200 being movably inserted in the inner chamber 110 and partitioning the inner chamber 110 into a main shaft chamber 111 and a spring chamber 112;
a transmission camshaft 300, the axial direction of the transmission camshaft 300 being perpendicular to the extending direction of the door closer housing 100, at the same time the transmission camshaft 300 being pivoted in the door closer housing 100 and accommodated in the main shaft chamber 111; and
a drive spring 400, the drive spring 400 being accommodated in the spring chamber 112, two ends of the drive spring 400 being abutted against the bidirectional piston 200 and the door closer housing 100 respectively, the drive spring 400 being configured to drive the bidirectional piston 200 to be abutted and pressed on the transmission camshaft 300;
wherein the bidirectional piston 200 is provided therethrough with a fluid channel 210 communicating with the main shaft chamber 111 and the spring chamber 112, and an overload valve 500 is installed in the fluid channel 210; the overload valve 500 is configured in a way that if the pressure in the main shaft chamber 111 exceeds a threshold pressure, the overload valve 500 allows the hydraulic oil to flow between the main shaft chamber 111 and the spring chamber 112.

Specifically, in this embodiment, the cam action hydraulic door closer excludes the gear and rack structure, that greatly simplifies the structure and volume of the door closer. The bidirectional piston 200 is consistently flexibly abutted against the outer peripheral surface of the transmission camshaft by the drive spring 400. When the transmission camshaft is working, it drives the bidirectional piston 200 to tightly press the drive spring 400, thereby realizing the force storing of the drive spring 400. At the same time, the flowing of the hydraulic oil between the main shaft chamber 111 and the spring chamber 112 is realized with the overload valve 500. Therefore, during the rotation of the door closer housing 100, the transmission camshaft receives the damping effect generated from the bidirectional piston 200 to the transmission camshaft and the damping effect of the hydraulic oil, that lowers the transient door closing speed. Thus, it is realized that the cam action hydraulic door closer achieves sufficient buffering when the door closes. It can be seen that the cam action hydraulic door closer of the present invention is simple in structure, convenient in assembly, and has the advantages of high production efficiency, low failure rate and stable performance.

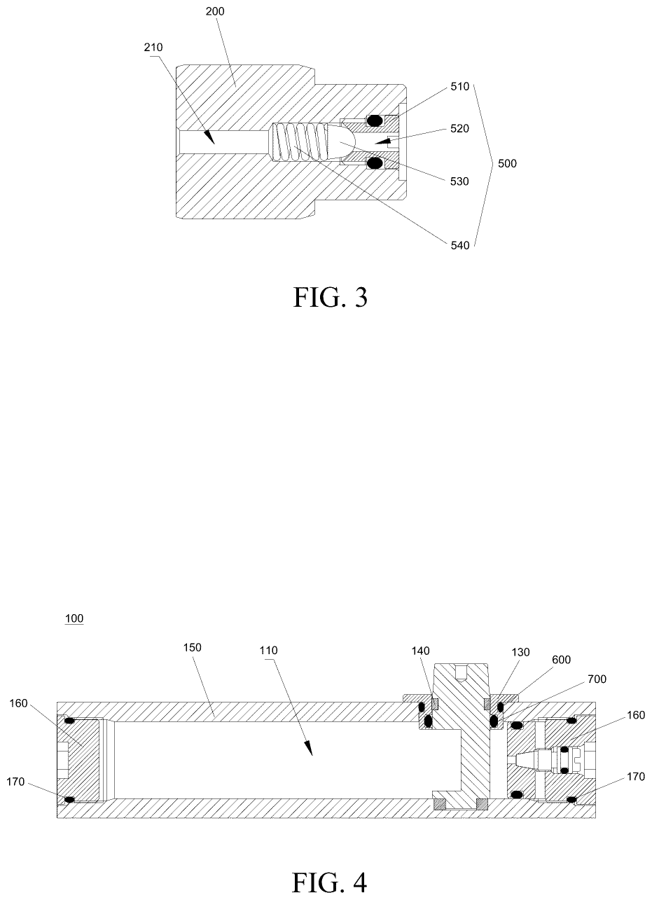

In a second embodiment of the present invention, as shown in FIG. 3, the overload valve 500 includes:
a valve body 510, the valve body 510 being installed in the fluid channel 210, at the same time the valve body 510 being provided therethrough with a valve flow channel 520 communicating with the main shaft chamber 111 and the fluid channel 210;
a valve core member 530, the valve core member 530 being movably disposed in the fluid channel 210 for realizing the open or shut of the valve flow channel 520; and
a valve core spring 540, the valve core spring 540 being accommodated in the fluid channel 210, an end of the valve core spring 540 being abutted in the bidirectional piston 200, another end of the valve core spring 540 being abutted against the valve core member 530 for driving the valve core member 530 to shut off the valve flow channel 520.

Specifically, in this embodiment, the movement of the valve core member 530 can realize the open or shut of the valve flow channel 520. The disposal of the valve core spring 540 can ensure the accuracy of the movement of the valve core member 530. When the main shaft chamber 111 and the spring chamber 112 have a pressure difference therebetween, which means the pressure in the main shaft chamber 111 exceeds the pressure of the spring chamber 112, the hydraulic oil can push the valve core member 530 to overcome the elastic force of the valve core spring 540 so as to move in the valve flow channel 520 to realize the open of the valve flow channel 520. After the pressure difference between the main shaft chamber 111 and the spring chamber 112 is balanced, the valve core member 530 is pushed by the elastic force of the valve core spring 540 to restore its position by moving in the valve flow channel 520, thereby realizing the shut of the valve flow channel 520. The status of the overload valve 500 is automatically changed, and the reliability is high.

The other parts of this embodiment are the same with the first embodiment. The features unexplained in this embodiment all adopt the explanation in the first embodiment, not repeatedly described here.

In a third embodiment of the present invention, as shown in FIG. 1, the door closer housing 100 is equipped with a first bushing 120 correspondingly to the lower end of the transmission camshaft 300. The door closer housing 100 is equipped with a positionally limiting installation seat 130 correspondingly to the upper end of the transmission camshaft 300, and at the same time the positionally limiting installation seat 130 is equipped with a second bushing 140. The midpoints of the first bushing 120 and the second bushing 140 are located on a same axis. The transmission camshaft 300 is inserted in the first bushing 120 and the second bushing 140.

Specifically, in this embodiment, the primary function of the first bushing 120 and the second bushing 140 is to fix the transmission camshaft. During the motion of the transmission camshaft, the first bushing 120 and the second bushing 140 generate the vibration reducing effect, and can help the transmission camshaft to stay balanced and stable, and at the same time can also reduce friction and wear, increasing the service life of the transmission camshaft.

The other parts of this embodiment are the same with the first embodiment. The features unexplained in this embodiment all adopt the explanation in the first embodiment, not repeatedly described here.

In a fourth embodiment of the present invention, as shown in FIG. 1, an outer sealing ring 600 is disposed between the outer end surface of the positionally limiting installation seat 130 and the door closer housing 100. An inner sealing ring 700 is disposed between the inner end surface of the positionally limiting installation seat 130 and the transmission camshaft 300.

Specifically, in this embodiment, in one aspect, the outer sealing ring 600 is consistently kept being tightly abutted against the outer end surface of the positionally limiting installation seat 130 and the door closer housing 100, so that it can be sealed between the positionally limiting installation seat 130 and the door closer housing 100 by the outer sealing ring 600. That disables the hydraulic oil in the inner chamber 110 from passing between the positionally limiting installation seat 130 and the door closer housing 100. In another aspect, the inner sealing ring 700 is consistently kept being tightly abutted against the inner end surface of the positionally limiting installation seat 130 and the transmission camshaft, so that it can be sealed between the positionally limiting installation seat 130 and the transmission camshaft by the inner sealing ring 700. That disables the hydraulic oil in the inner chamber 110 from passing between the positionally limiting installation seat 130 and the transmission camshaft.

The other parts of this embodiment are the same with the fourth embodiment. The features unexplained in this embodiment all adopt the explanation in the fourth embodiment, not repeatedly described here.

In a fifth embodiment of the present invention, as shown in FIGS. 1-2, the novel cam action hydraulic door closer further includes two fastening installation members 800. The two fastening installation members 800 are respectively disposed at two ends of the door closer housing 100 symmetrically. At the same time the fastening installation member 800 and the door closer housing 100 are fastened to each other by several fastening screws.

Specifically, in this embodiment, by additionally disposing two fastening installation members 800 at two ends of the door closer housing 100, it is convenient to install and fix the cam action hydraulic door closer, and at the same time the contact area between the cam action hydraulic door closer and the door body is increased, thereby raising the reliability and stability of fitting the cam action hydraulic door closer with the door body to avoid sway.

The other parts of this embodiment are the same with the first embodiment. The features unexplained in this embodiment all adopt the explanation in the first embodiment, not repeatedly described here.

In a sixth embodiment of the present invention, as shown in FIGS. 1-2, the fastening installation member 800 is configured in an L-shape, and includes a door body connecting plate 810 and a housing connecting plate 820, which are formed integrally. The door body connecting plate 810 is disposed horizontally and fastened to the door body by several fastening screws. The housing connecting plate 820 is disposed vertically and fastened to the door closer housing 100 by several fastening screws.

Specifically, in this embodiment, the door body connecting plate 810 and the housing connecting plate 820 are formed integrally, so that the whole fastening installation member 800 has high structural strength. That is safe and reliable during subsequent use, satisfying the requirement that the cam action hydraulic door closer is fit and installed firmly to the door body.

The other parts of this embodiment are the same with the fifth embodiment. The features unexplained in this embodiment all adopt the explanation in the fifth embodiment, not repeatedly described here.

In a seventh embodiment of the present invention, as shown in FIGS. 1-2, the door body connecting plate 810 and the housing connecting plate 820 are both provided therethrough with fastening holes 830 for disposing the fastening screws.

Specifically, in this embodiment, the door body connecting plate 810 and the housing connecting plate 820 are pre-drilled with fastening holes 830, so they don't need to be drilled during the installation. Thus, the cam action hydraulic door closer can be fast installed and fastened by using the fastening screws.

The other parts of this embodiment are the same with the sixth embodiment. The features unexplained in this embodiment all adopt the explanation in the sixth embodiment, not repeatedly described here.

In an eighth embodiment of the present invention, as shown in FIG. 4, the door closer housing 100 includes:
a housing main body 150, the housing main body 150 being hollow inside and having two lateral openings, the transmission camshaft 300 being pivoted to the housing main body 150; and
two sealing end caps 160, the two sealing end caps 160 being fixedly disposed on the two lateral openings of the housing main body 150 respectively to form the inner chamber 110 in an enclosed manner, an end cap sealing ring 170 being disposed between the outer end surface of the sealing end cap 160 and the housing main body 150.

Specifically, in this embodiment, the housing main body 150 and the two sealing end caps 160 of the door closer housing 100 are detachably connected. In one aspect, the operation of maintaining the whole cam action hydraulic door closer is greatly simplified. The operator can do the disassembly and maintenance quickly and conveniently. In another aspect, the detachable structure facilitates the maintenance and replacement of the single housing main body 150 or sealing end cap 160, thereby lowering the maintenance cost.

The other parts of this embodiment are the same with the first embodiment. The features unexplained in this embodiment all adopt the explanation in the first embodiment, not repeatedly described here.

The above description is only the preferred embodiments of the present invention, not intended to limit the present invention. Any modification, equivalent substitution and improvement made within the spirit and principle of the present invention should be included within the claimed scope of the present invention.

What is claimed is:

1. A novel cam action hydraulic door closer comprising:
a door closer housing, the door closer housing being provided therein along an axis direction thereof with an inner chamber filled with hydraulic oil;
a bidirectional piston, the bidirectional piston being movably inserted in the inner chamber and partitioning the inner chamber into a main shaft chamber and a spring chamber;
a transmission camshaft, an axial direction of the transmission camshaft being perpendicular to an extending direction of the door closer housing, at the same time the transmission camshaft being pivoted in the door closer housing and accommodated in the main shaft chamber; and
a drive spring, the drive spring being accommodated in the spring chamber, two ends of the drive spring being abutted against the bidirectional piston and the door closer housing respectively, the drive spring being configured to drive the bidirectional piston to be abutted and pressed on the transmission camshaft;
wherein the bidirectional piston is provided therethrough with a fluid channel communicating with the main shaft chamber and the spring chamber, and an overload valve is installed in the fluid channel; the overload valve is configured in a way that if pressure in the main shaft chamber exceeds a threshold pressure, the overload valve allows the hydraulic oil to flow between the main shaft chamber and the spring chamber.

2. The novel cam action hydraulic door closer as claimed in claim 1, wherein the overload valve comprises:
a valve body, the valve body being installed in the fluid channel, at the same time the valve body being provided therethrough with a valve flow channel communicating with the main shaft chamber and the fluid channel;
a valve core member, the valve core member being movably disposed in the fluid channel for realizing open or shut of the valve flow channel; and
a valve core spring, the valve core spring being accommodated in the fluid channel, an end of the valve core spring being abutted in the bidirectional piston, another end of the valve core spring being abutted against the valve core member for driving the valve core member to shut off the valve flow channel.

3. The novel cam action hydraulic door closer as claimed in claim 1, wherein the door closer housing is equipped with a first bushing correspondingly to a lower end of the transmission camshaft; the door closer housing is equipped with a positionally limiting installation seat correspondingly to an upper end of the transmission camshaft, and at the same time the positionally limiting installation seat is equipped with a second bushing; midpoints of the first bushing and the second bushing are located on a same axis; the transmission camshaft is inserted in the first bushing and the second bushing.

4. The novel cam action hydraulic door closer as claimed in claim 3, wherein an outer sealing ring is disposed between an outer end surface of the positionally limiting installation seat and the door closer housing; an inner sealing ring is disposed between an inner end surface of the positionally limiting installation seat and the transmission camshaft.

5. The novel cam action hydraulic door closer as claimed in claim 1, wherein the novel cam action hydraulic door closer further comprises two fastening installation members; the two fastening installation members are respectively disposed at two ends of the door closer housing symmetrically; at the same time the fastening installation member and the door closer housing are fastened to each other by several fastening screws.

6. The novel cam action hydraulic door closer as claimed in claim 5, wherein the fastening installation member is configured in an L-shape, and comprises a door body connecting plate and a housing connecting plate, which are formed integrally; the door body connecting plate is disposed horizontally and fastened to a door body by several fastening screws; the housing connecting plate is disposed vertically and fastened to the door closer housing by several fastening screws.

7. The novel cam action hydraulic door closer as claimed in claim 6, wherein the door body connecting plate and the housing connecting plate are both provided therethrough with fastening holes for disposing the fastening screws.

8. The novel cam action hydraulic door closer as claimed in claim 1, wherein the door closer housing comprises:
a housing main body, the housing main body being hollow inside and having two lateral openings, the transmission camshaft being pivoted to the housing main body; and
two sealing end caps, the two sealing end caps being fixedly disposed on the two lateral openings of the housing main body respectively to form the inner chamber in an enclosed manner, an end cap sealing ring being disposed between an outer end surface of the sealing end cap and the housing main body.
